(19) United States
(12) Patent Application Publication
(10) Pub. No.: US 2005/0076736 A1
(43) Pub. Date: Apr. 14, 2005

(54) Tilt-adjusting type steering apparatus

(75) Inventor: Kenji Sato, Gunma-ken (JP)

Correspondence Address: MILES & STOCKBRIDGE PC, 1751 PINNACLE DRIVE, SUITE 500, MCLEAN, VA, 22102-3833, US

(73) Assignee: NSK Ltd.

(21) Appl. No.: 10/653,254

(22) Filed: Sep. 3, 2003

(30) Foreign Application Priority Data
Sep. 4, 2002 (JP) 2002-258953
Jul. 25, 2003 (JP) 2003-201920

(51) Int. Cl. B62D 1/18

(52) U.S. Cl. 74/493

(57) ABSTRACT

A tilt adjusting type steering apparatus comprises a rear steering shaft, a front steering shaft, a universal joint coupling the rear steering shaft and the front steering shaft, a front support member, a rear support member, and an operation mechanism including a fixed gear secured to the front support member and a movable gear supported to be rotatable by the rear support member. The operation mechanism causes the movable gear to be meshed with the fixed gear to secure the rear support member at a tilt adjusted position and releases the movable gear from the fixed gear at the time of tilt adjusting. The fixed gear is integrally formed with a convex part, and the front support member is formed with a concave part. These parts are fitted to each other to secure the fixed gear to the front support member.

This application claims the benefit of Japanese Patent Applications No. 2002-258953 and No. 2003-201920 which are hereby incorporated by reference.

### BACKGROUND OF THE INVENTION

1. Field of the Invention

The present invention relates to a tilt adjusting type steering apparatus capable of adjusting an angle of inclination of a steering wheel of a vehicle.

2. Related Background Art

There is known a tilt adjusting type steering apparatus which is capable of adjusting an angle of inclination of a steering wheel in accordance with the physic or a driving posture of a driver. In this tilt adjusting type steering apparatus, as disclosed, for example, in Japanese Patent Application Laid-Open No. 1997-2291 or Japanese Patent Application Laid-Open No. 2000-255435, a rear steering column is rockably connected to the rear portion of a front steering column through a support bracket which is secured to the car body.

An arrangement of the tilt adjusting type steering apparatus is such that a tilt adjusting lever is rocked so as to rock a movable gear attached to the rear steering column with respect to a fixed gear disposed on the support bracket, whereby the teeth of the movable gear is brought into engagement with the teeth of the fixed gear to effect tilt fastening, or this engagement is released to effect tilt release.

In the tilt adjusting type steering apparatus disclosed in Japanese Patent Application Laid-Open No. 1997-2291, in order to secure the fixed gear to the support bracket, the fixed gear is fitted to the support bracket, in addition to bolt fixation, and a concave part is formed on the fixed gear. On the other hand, a convex part is formed on the support bracket.

In these days, it is demanded to decrease an amount of protrusion on a lower side of the steering column, in order to reduce a damage which may be caused when a knee of the driver is hit in collision of the vehicle.

Also in the structure disclosed in Japanese Patent Application Laid-Open No. 1997-2291, in order to reduce the amount of protrusion on the lower side of the steering column, the fixed gear may be formed thinner.

However, since the concave part is formed on the fixed gear in the structure disclosed in Japanese Patent Application Laid-Open No. 1997-2291, the strength of the fixed gear is reduced when the fixed gear becomes thinner, so that there is a limit to the thinning of the fixed gear.

On the other hand, in the tilt adjusting type steering apparatus disclosed in Japanese Patent Application Laid-Open No. 2000-255435, in addition to the bolt fixation, the fixed gear is fitted to the support bracket so that the cylindrical convex part is formed on the fixed gear, while the cylindrical concave part is formed on the support bracket.

In this case, since the convex part is formed on the fixed gear, the fixed gear can be formed thinner, compared with the structure of the above Japanese Patent Application Laid-Open No. 1997-2291.

However, in case of FIG. 6 of Japanese Patent Application Laid-Open No. 2000-255435, the convex part is in a cylindrical form, so that it is difficult to form this convex part.

For instance, when the convex part is formed by sintering, if a crevice of a mold is placed in a perpendicular direction with respect to the fixed gear, since there is a cylindrical convex part, the crevice of the mold is positioned at the center of the fixed gear (in the cylindrical convex part), so that it is impossible to conduct the formation.

Also, when the crevice of the mold is positioned in a horizontal direction along a surface on which the protrusion of the fixed gear is formed, the density of the material of the teeth of the fixed gear may become coarse, and the strength of the fixed gear may be reduced.

### SUMMARY OF THE INVENTION

The present invention has been contrived taking the circumstance described above into consideration, and an object of the present invention is to provide a tilt adjusting type steering apparatus a fixed gear of which can be formed easily with the sufficiently improved strength.

In order to achieve the above object, according to the present invention, there is provided a tilt adjusting type steering apparatus comprising:
a rear steering shaft adapted to be provided with a steering wheel at a rear end thereof;
a front steering shaft adapted to be provided with a steering gear at a front end thereof;
a universal joint for coupling the rear steering shaft and the front steering shaft;
a front support member for rotatably supporting the front steering shaft, and adapted to be fixed to a strength member of a body of a vehicle;
a rear support member for rotatably supporting the rear steering shaft, and adapted to be supported to be rotatable at a rear position of the front support member for allowing tilt adjustment; and
an operation mechanism including a fixed gear secured to the front support member and a movable gear supported to be rotatable by the rear support member to be meshed with the fixed gear, the operation mechanism causing the movable gear to be meshed with the fixed gear to secure the rear support member at a tilt adjusted position with respect to the front support member and releasing the movable gear from the fixed gear at the time of tilt adjusting, wherein:
said fixed gear is integrally formed with a convex part which has a substantially same cross-sectional form in the width direction of the vehicle to face the front support member; and
said front support member is formed with a concave part to be corresponding to the convex part and these convex and concave parts are fitted to each other to secure said fixed gear to the front support member.

According to another aspect of the present invention, there is provided a tilt adjusting type steering apparatus in which a rear steering column is rockably connected to a rear portion of a front steering column through a support bracket secured to a body of a vehicle, a tilt adjusting lever is rocked to rock, with respect to a fixed gear disposed on one of the support bracket and the rear steering column, a movable gear disposed on the other of the support bracket and the rear steering column, and the teeth of the movable gear are releasably engaged with the teeth of the fixed gear, which apparatus characterized in that:
said fixed gear is formed with a convex part while either one of said support bracket and said rear steering column is formed with a concave part so that said fixed gear is brought into fitting with said either one of said support bracket and said rear steering column; and
the convex part of said fixed gear has a substantially identical cross-sectional form in the width direction of the vehicle.

As described above, according to the present invention, since the convex part of the fixed gear has a substantially same cross-sectional form in the width direction of the vehicle, it becomes easier to form the fixed gear by sintering or drawing, and since the density of the materials of the convex part and the teeth can be increased, it is possible to obtain sufficiently improved strength of the fixed gear.

Note that in the present specification, the concave part is not limited to a groove, or a hole with a bottom, but may include a through hole.

Also, in the tilt adjusting type steering apparatus according to the present invention, the fixed gear may be preferably formed by sintering or drawing. According to such a preferred feature of the present invention, when the fixed gear is formed by sintering or drawing, since the convex part of the fixed gear has a substantially same cross-sectional form in the width direction of the vehicle, the convex part can be formed easily and the material density of the convex part and the teeth can be increased.

Further, in the tilt adjusting type steering apparatus according to the present invention, it is preferable that the convex part of the fixed gear has an inclined surface in the longitudinal direction of the vehicle. According to such a preferred feature of the present invention, when the fixed gear is formed by sintering or the like, it is possible to stabilize the material density of the corner parts of the convex part more, so that the strength thereof can be further more stabilized.

Further, in the tilt adjusting type steering apparatus according to the present invention, it is preferable that the convex part of the fixed gear is extended in the width direction described above from one side end of the fixed gear. This structure is suitable to be formed by sintering, so that the material density of the convex part and the teeth can be increased and the strength of the fixed gear can be sufficiently enhanced.

### BRIEF DESCRIPTION OF THE DRAWINGS

FIG. 1 is a side view for showing the entire structure of a tilt adjusting type steering apparatus according to the present invention;

FIG. 2 is a longitudinal cross-sectional view of a tilt adjusting type steering apparatus according to a first embodiment of the present invention;

FIG. 3 is a longitudinal cross-sectional view of the tilt adjusting type steering apparatus shown in FIG. 2, in which a tilt adjusting lever structure is added to the apparatus of FIG. 2 (hatching of the cross section is omitted for clarification);

FIG. 4 is a bottom view of the tilt adjusting type steering apparatus shown in FIG. 2, seen from below;

FIG. 5 is a cross-sectional view taken along line A-A in FIG. 2;

FIG. 6 is a longitudinal cross-sectional view of the tilt adjusting type steering apparatus shown in FIG. 2, at the time when a fixed gear is assembled thereto;

FIG. 7 is a perspective view of a fixed gear according to the first embodiment;

FIG. 8 is a perspective view of the fixed gear according to a variation of the first embodiment;

FIG. 9 is a longitudinal cross-sectional view of a tilt adjusting type steering apparatus according to a second embodiment of the present invention;

FIG. 10 is a longitudinal cross-sectional view of a tilt adjusting type steering apparatus according to a third embodiment of the present invention; and

FIG. 11 is a bottom view of the tilt adjusting type steering apparatus shown in FIG. 10.

### DETAILED DESCRIPTION OF PREFERRED EMBODIMENTS

A tilt adjusting type steering apparatus according to an embodiment of the present invention will be described below with reference to the drawings.

(The Entire Structure of the Tilt Adjusting type Steering Apparatus)

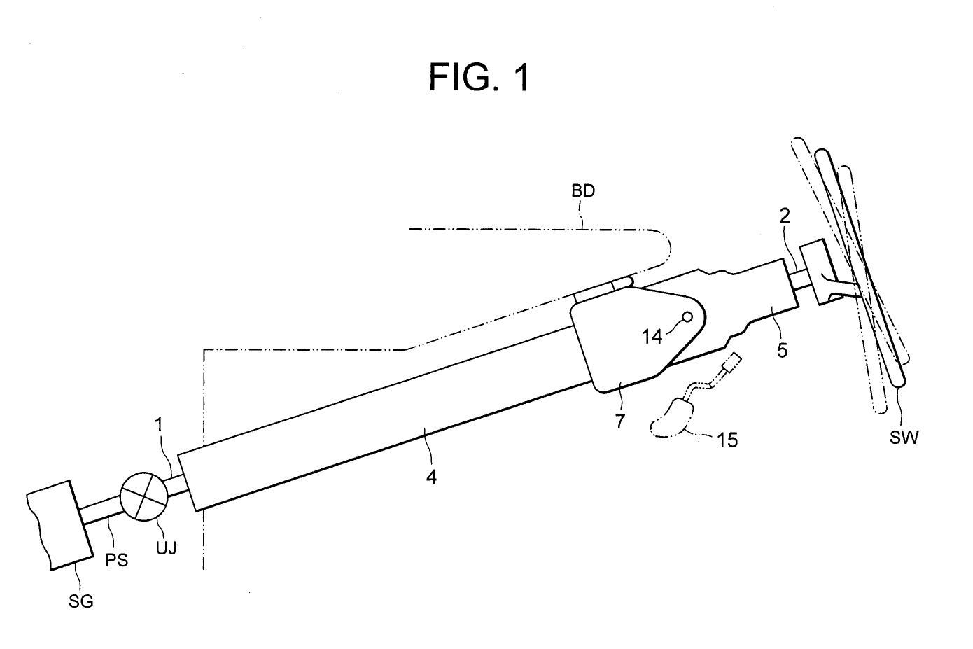

FIG. 1 is a side view for showing the entire structure of the tilt adjusting type steering apparatus according to the present invention.

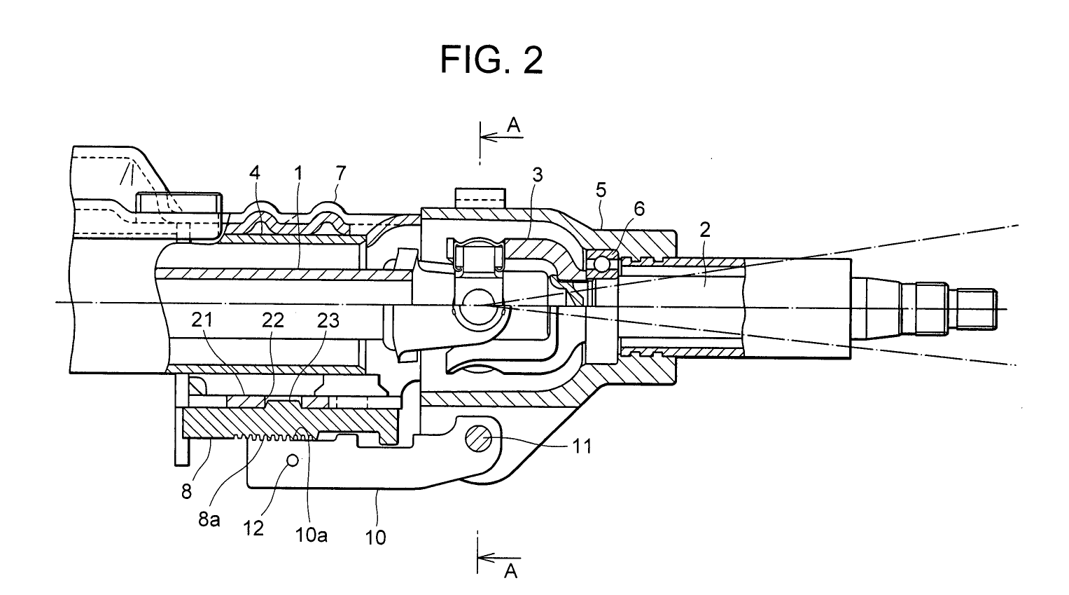

As shown in FIG. 1, in the tilt adjusting type steering apparatus according to the present invention, a steering shaft is comprised of a front steering shaft 1 and a rear steering shaft 2, and these shafts 2 and 3 are coupled to each other by a universal joint 3 (FIG. 2 and the like). Note that the front steering shaft 1 is connected to a pinion shaft PS of a steering gear SG through a universal joint UJ.

The front steering shaft 1 is rotatably accommodated in a front steering column 4, and the rear steering shaft 2 is rotatably accommodated in a rear steering column 5 through a bearing 6 (FIG. 2, and the like).

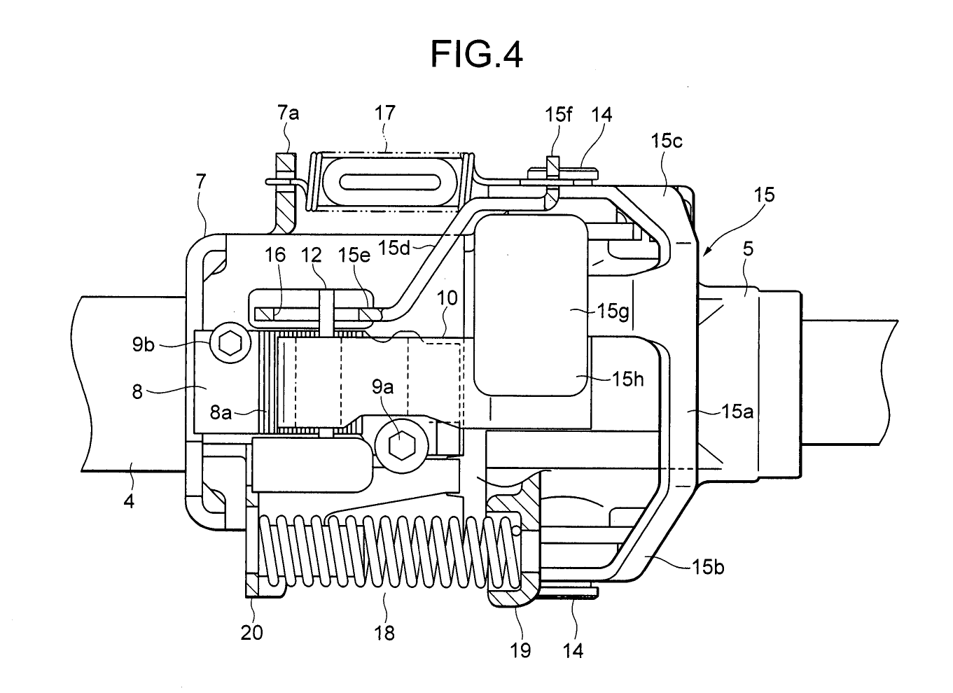

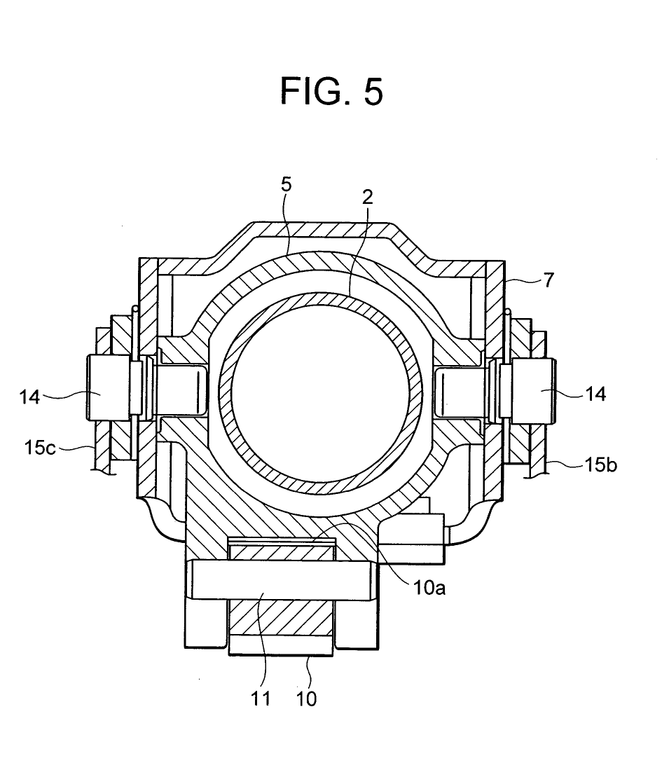

A support bracket 7 secured to a body BD of a vehicle is fitted on a rear portion of the front steering column 4, and the rear steering column 5 is rockably connected to the support bracket 7. Then, the rear steering column 5 is arranged to be rockable about pivots 14 which are provided on the sides of the steering column 5 (FIGS. 4 and 5).

Note that the rear steering column 5 is secured to the vehicle body BD through the support bracket 7. However, it may be secured to the vehicle body BD through the front steering column 4 serving as an inner column.

(First Embodiment)

FIG. 2 is a longitudinal cross-sectional view of a tilt adjusting type steering apparatus according to a first embodiment of the present invention.

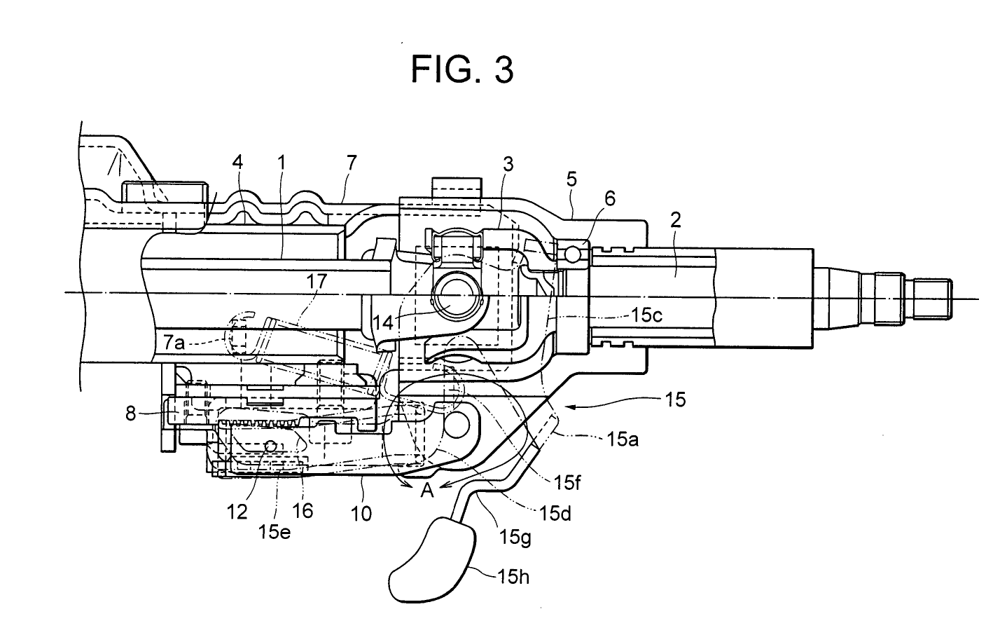

FIG. 3 is a longitudinal cross-sectional view of the tilt adjusting type steering apparatus shown in FIG. 2, in which a tilt adjusting lever structure is added to the apparatus of FIG. 2 (the hatching of a cross section is omitted for clarification).

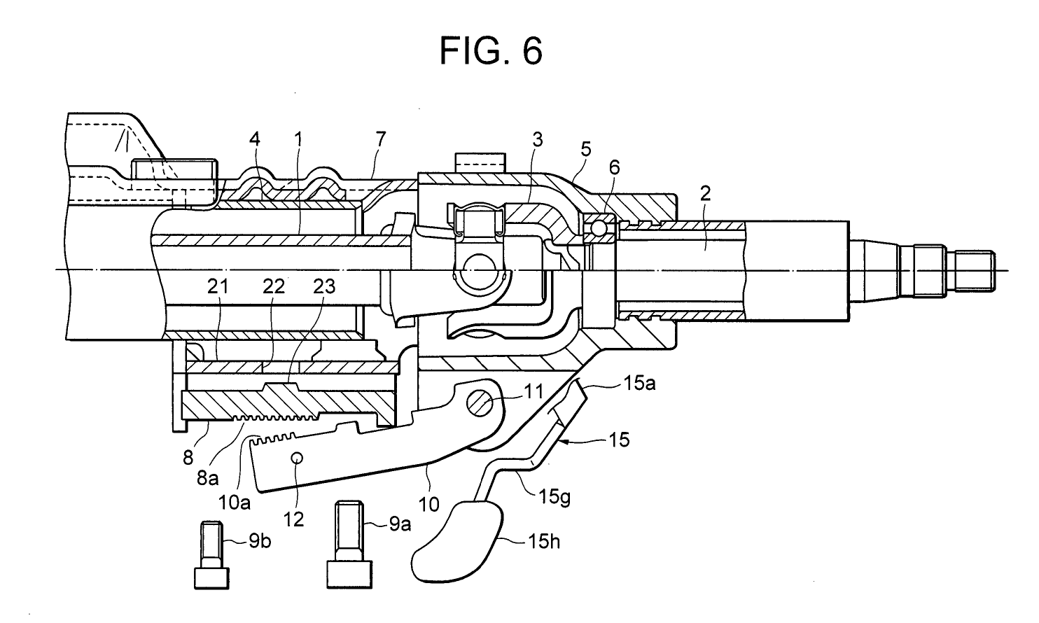

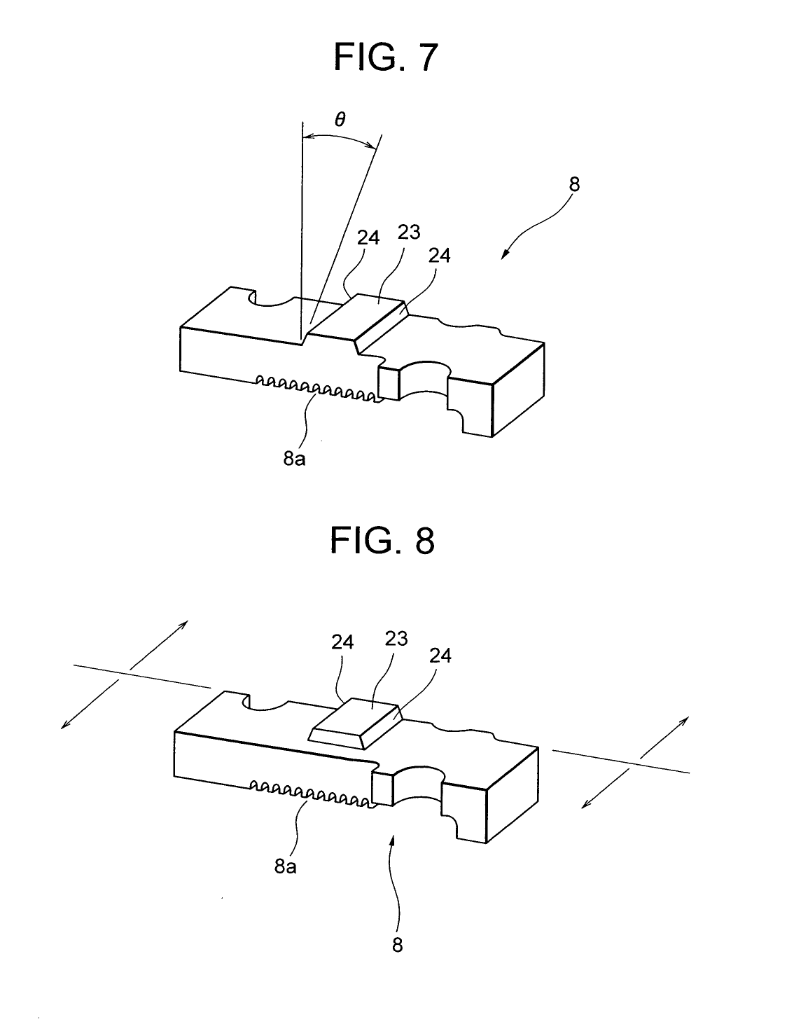

FIG. 4 is a bottom view of the tilt adjusting type steering apparatus shown in FIG. 2, seen from below. FIG. 5 is a cross-sectional view taken along line A-A in FIG. 2. FIG. 6 is a longitudinal cross-sectional view of the tilt adjusting type steering apparatus shown in FIG. 2 at the time when the fixed gear is assembled. FIG. 7 is a perspective view of a fixed gear according to the first embodiment. FIG. 8 is a perspective view of a fixed gear according to a variation of the first embodiment.

As described above, the steering shaft is comprised of the front steering shaft 1, the rear steering shaft 2 and the universal joint 3 for connecting these shafts. The front steering shaft 1 is rotatably accommodated in the front steering column 4 through a bearing (not shown), and the rear steering shaft 2 is rotatably accommodated in the rear steering column 5 by means of a ball bearing 6. The rear steering column 5 is rockably connected to the rear portion of the front steering column 4 through a support bracket 7 which is secured to the vehicle body, and the rear steering column 5 is arranged to rock around pivots 14, 14 (FIGS. 4 and 5) disposed on the sides of the rear steering column 5.

A fixed gear 8 having teeth 8a is secured to a lower surface (attachment portion 21) of the support bracket 7 by means of bolts 9a, 9b (FIG. 6). A movable gear 10 having teeth 10a to be meshed with the teeth 8a is pivotally supported to be rockable by a pivot 11 which is provided on the rear steering column 5. A pin 12 is press-fitted and secured to the movable gear 10. The pin 12 is to be slidably engaged with a diamond-shaped engagement hole 16 (FIG. 3) formed on a tilt adjusting lever 15 (to be described later).

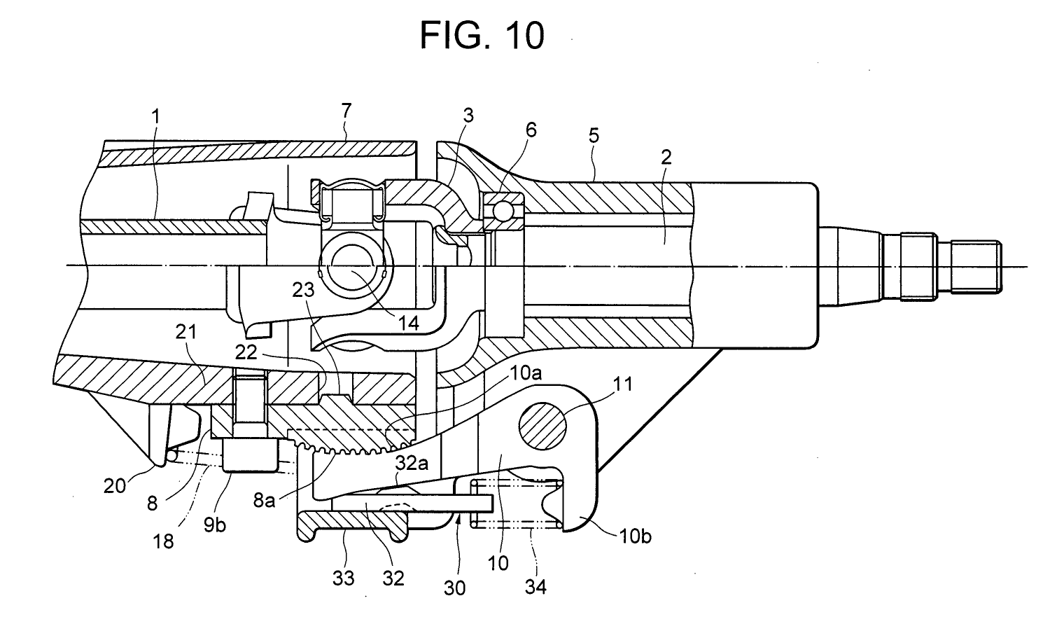

The teeth 8a and the teeth 10a are formed linearly (rack-shaped). However, as shown in FIG. 10, the teeth 8a and the teeth 10a may be arcuate.

Also, as shown in FIGS. 3, 4 and 5, a tilt adjusting lever 15 is pivotally secured to be rotatable by pivots 14, 14 to the sides of the rear steering column 5.

This tilt adjusting lever 15 is comprised of a spanning portion 15a for spanning in the lateral direction of the vehicle on the bottom side of the support bracket 7, etc., a pair of side portions 15b, 15c standing up sideward from the spanning portion 15a to be pivotally secured to be rockable by the pivots 14, an extending portion 15d extending while bending toward the front part of the vehicle from one of the side portions 15c, a tip end portion 15e further extending toward the front part of the vehicle from the extending portion 15d and provided with the diamond-shaped engagement hole 16 described above (FIG. 3), a latching portion 15f formed to protrude from one of the side portions 15c, a protrusion portion 15g protruding toward the front part of the vehicle from the spanning portion 15a and substantially downward, and a grip portion 15h formed at the tip end of the protrusion portion 15g.

The tilt adjusting lever 15 is provided with a tension spring 17 for biasing the tilt adjusting lever 15 toward the front part of the vehicle (that is, in the clockwise direction around the pivot 14 in FIG. 3), and the tension spring 17 is suspended across the latch portion 15f of the side portion 15c and the latch portion 7a of the support bracket 7, as shown in FIGS. 3 and 4.

As shown in FIG. 4, a support spring 18 serving as a compression spring is interposed between a bracket 19 of the rear steering column 5 and a support spring bracket 20 of the support bracket 7. With this arrangement, it is possible to prevent decent of the steering wheel, and the like, when the engagement between the teeth 10a of the movable gear 10 and the teeth 8a of the fixed gear 8 is released.

When an angle of inclination of the steering wheel is to be adjusted in the tilt adjusting type steering apparatus arranged as described above, if the tilt adjusting lever 15 causes the grip portion 15h to move or rock toward the rear part of the vehicle (that is, in the counter-clockwise direction around the pivots 14, 14 in FIG. 3) to resist the biasing force of the tension spring 17, the spanning portions 15a, the side portions 15b, 15c, the extension portion 15d, and the tip end portion 15e are integrally rocked toward the rear part of the vehicle, so as to depress downward the pin 12 of the movable gear 10 which is engaged with the diamond-shaped engagement hole 16 (FIG. 3) at the tip end portion l5e.

Thereby the movable gear 10 is rocked around the movable gear pivot 11, so that the teeth 10a of the movable gear 10 are released from the engagement with the teeth 8a of the fixed gear 8. With this arrangement, it is possible to adjust an angle of inclination of the steering wheel (not shown) secured to the rear end of the rear steering shaft 2.

After the adjustment of the angle of inclination of the steering wheel, if the tilt adjusting lever 15 causes the grip portion 15h to rock toward the front part of the vehicle (that is, in the clockwise direction around the pivot 14 in FIG. 3) by means of the biasing force of the tension spring 17, the spanning portion 15a, the side portions 15b, 15c, the extension portion 15d and the tip end portion 15e are integrally rocked toward the front part of the vehicle, so as to press up the pin 12 of the movable gear 10 which is engaged with the diamond-shaped engagement hole 16 (FIG. 3) of the tip end portion 15e.

Thereby the movable gear 10 is rocked around the pivot 11, and the teeth 10a of the movable gear 10 are brought into engagement with the teeth 8a of the fixed gear 8. With this arrangement, the steering wheel (not shown) can be secured in its state after having been adjusted.

Further, in the present embodiment, a concave part 22 (through hole) is formed in an attachment portion 21 which is provided on the lower surface of the support bracket 7, and on the fixed gear 8 a convex part 23 is formed by sintering or drawing to be fit in this concave part 22. Note that the attachment portion 21 of the support bracket 7 is formed of, for example, a plate having the thickness of about 4.0 mm. The concave part 22 is a through hole in this case, but may be a groove or a hole with the bottom.

Also, as shown in FIG. 6, the concave part 22 of the attachment portion 21 and the convex part 23 of the fixed gear 8 are provided with a space therebetween, so that it is possible to match the degree of parallelism of the teeth 8a of the fixed gear 8 with that of the teeth 10a of the movable gear 10.

As shown in FIG. 7, the convex part 23 has a cross-section in a trapezoidal form and is substantially identically shaped in the width direction of the vehicle (the width direction of the fixed gear 8). The convex part 23 is extended over the entire width of the fixed gear 8 from one side end of the fixed gear 8.

The both side faces 24 of the convex part 23 make an inclination by a predetermined angle (θ) in the longitudinal direction of the vehicle and the ridge of the convex part 23 is chamfered.

As described above, according to the present embodiment, the convex part 23 of the fixed gear 8 has the substantially same cross-sectional form in the width direction of the vehicle, so that it becomes easier to form the fixed gear 8 by sintering or drawing, and since the material density of the convex part 23 and the teeth 8a can be increased, it is possible to sufficiently enhance the strength of the fixed gear 8.

Further, since the convex part 23 of the fixed gear 8 and its both side faces 24 in the longitudinal direction of the vehicle are inclined, when the fixed gear 8 is formed by sintering, or the like, the material density of the corners of the convex part 23 can be more stabilized, so that the strength of the fixed gear 8 can be further stabilized.

Further, since the convex part 23 of the fixed gear 8 is extended in the width direction described above from the one side end of the fixed gear 8, the fixed gear is suited to be formed by sintering or drawing and the material density of the convex part 23 and the fitting teeth 8a can be increased. Thus, the strength of the fixed gear can be enhanced sufficiently.

Note that, as shown in FIG. 8, the convex part 23 having the same cross-sectional form in the width direction is extended from the one side end thereof, over a predetermined length, instead of extended over the entire width of the fixed gear 8. In this case, a crevice of a mold for sintering can be set along one end of the fixed gear 8 in the vertical direction, as shown in FIG. 8, so that the fixed gear with such a shape can be formed by sintering easily.

The outer peripheral surface of the pivot shaft 11 of the movable gear 10 is formed in a cylindrical form so that a general-purpose article such as a rod-shaped roller or a needle-shaped roller for a bearing with high precision may be used, which is advantageous in terms of the manufacturing cost. Lubricant reserving grooves are formed linearly in the axial direction on the inner peripheral surface of the through hole of the movable gear 10 in which the pivot shaft 11 is inserted. This lubricant reserving grooves can store a lubricant (such as grease) in a sealing manner, and can conduct lubrication between the through hole of the movable gear 10 and the movable gear pivot 11 excellently.

(Second Embodiment)

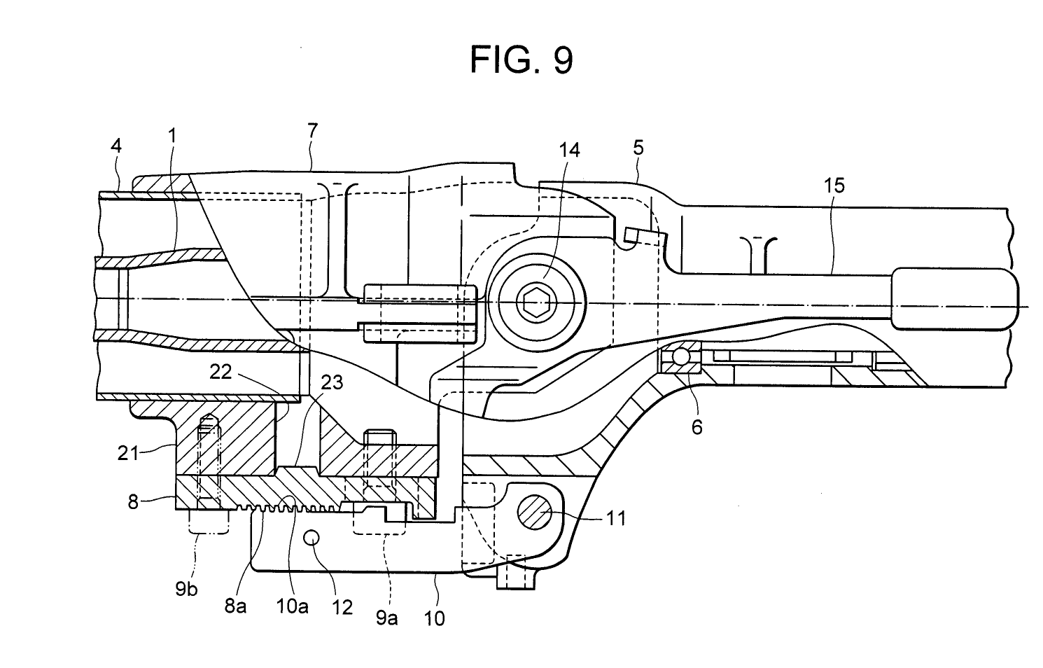

FIG. 9 is a longitudinal cross-sectional view of a tilt adjusting type steering apparatus according to a second embodiment of the present invention.

In the second embodiment, the support bracket 7 is formed by die casting, and the attachment portion 21 is also formed by die casting at the same time. Since the concave part 22 is formed by die casting, a machine work is not required.

In the same manner as in the first embodiment, the convex part 23 of the fixed gear 8 has the substantially same cross-sectional form in the width direction of the vehicle, so that the formation of the fixed gear 8 by sintering or drawing becomes easier. Also, since the material density of the convex part 23 and the teeth 8a can be increased, the strength of the fixed gear 8 can be sufficiently enhanced. Other structures and effects of the second embodiment are the same as those of the first embodiment.

(Third Embodiment)

FIG. 10 is a longitudinal cross-sectional view of a tilt adjusting type steering apparatus according to a third embodiment of the present invention.

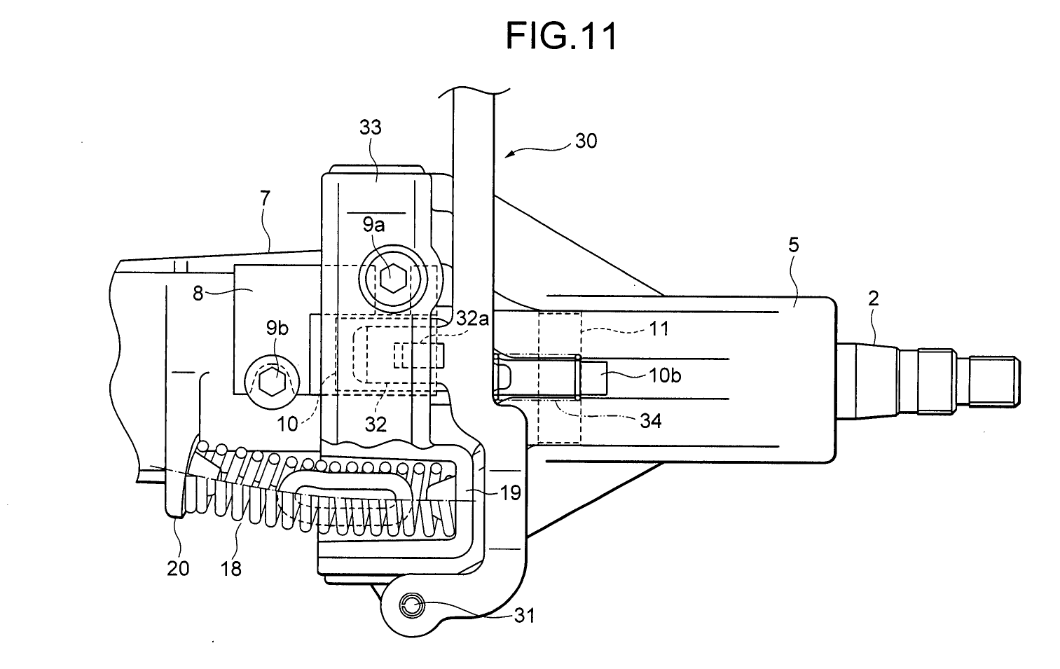

FIG. 11 is a bottom view of the tilt adjusting type steering apparatus shown in FIG. 10.

In the third embodiment, as shown in FIG. 11, a tilt adjusting lever 30 is spanned laterally in the width direction of the vehicle, so as to be rocked substantially in the longitudinal direction of the vehicle around a pivot 31 which is provided on a side of the rear steering column 5.

At a substantially mid portion of the tilt lever 30, a lock portion 32 is formed to protrude toward the front part of the vehicle. More specifically, the lock portion 32 is provided to be movable in the longitudinal direction of the vehicle in an interlocking manner with the tilt adjusting lever 30 and, as shown in FIG. 10, this lock portion 32 is provided with a wedge portion 32a which is arranged to be locked when sandwiched by and between the movable gear 10 and a fixing member 33 serving as a reaction member.

Note that the fixing member 33 (reaction member) is formed by die casting integrally with the rear steering column 5, and is spanned in the width direction of the vehicle. The fixed gear 8 is fixed by means of the bolts 9a and 9b (FIG. 11).

A compression coil spring 34 is interposed between a substantially rear part of the lock portion 32 and a hook portion 10b which is extended from the movable gear 10. This compression coil spring 34 all the time biases the teeth 10a of the movable 10 through the wedge portion 32a in a direction of the mutual fit with the teeth 8a of the fixed gear 8. However, the compression coil spring 34 acts, when the tilt position fastening is released, also to bias the movable gear 10 in the direction of releasing through the hook portion 10b.

The teeth 8a of the fixed gear 8 are formed to be convex arcuate, while the teeth 10a of the movable gear 10 are formed to be concave arcuate to correspond to the convex arcuate form. The centers of these arcuate forms coincide with the tilt rocking center (14).

In the tilt lock mechanism arranged as described above, when tilt adjustment is to be effected, the tilt adjusting lever 30 is rocked toward the rear part of the vehicle to resist the biasing force of the compression coil spring 34, so as to retract the wedge portion 32a of the rock portion 32 backward.

As a result, the movable gear 10 is rotated with the help of the biasing force of the compression coil spring 34 to be released from the fitting with the fixed gear 8. With this arrangement, fastening of the steering column to the tilt adjustment position can be released.

After the tilt adjustment, when the operator releases his or her hold of the tilt lever 30, the tilt lever 30 is rocked frontward of the vehicle by the biasing force of the compression coil spring 34, so as to move the wedge portion 32a of the lock portion 32 frontward.

As a result, the teeth 10a of the movable gear 10 are pressed with pressure upon the teeth 8a of the fixed gear 8 by the wedge portion 32a of the lock portion 32 which is biased by the compression coil spring 34 to be brought into tight fitting therewith. With this arrangement, the steering column can be fastened at the tilt-adjusted position.

In the same manner as in the foregoing embodiments, since the convex part 23 of the fixed gear 8 has the substantially identical cross-sectional form in the width direction of the vehicle, the fixed gear 8 can be formed by sintering or drawing easily. Also, since the material density of the convex part 23 and the teeth 8a can be increased, the strength of the fixed gear 8 can be sufficiently enhanced. Other arrangements and effects are the same as those of the foregoing embodiments.

Note that the present invention is not limited to the embodiments described above, but may be altered in various manners. For example, though the movable gear is pivotally supported by the rear steering column and the fixed gear is mounted to the support bracket in the foregoing embodiments, it may be arranged such that the movable gear is pivotally supported by the support bracket and the fixed gear is mounted to the rear steering column.

As described above, according to the present invention, it becomes easier to form the fixed gear by sintering or drawing, and to enhance the strength of the fixed gear sufficiently.

1. A tilt-type steering apparatus comprising:
a rear steering shaft adapted to be provided with a steering wheel at a rear end thereof;
a front steering shaft adapted to be provided with a steering gear at a front end thereof;
a universal joint for coupling the rear steering shaft and the front steering shaft;
a front support member for rotatably supporting the front steering shaft, and adapted to be fixed to a strength member of a body of a vehicle;
a rear support member for rotatably supporting the rear steering shaft, and adapted to be supported to be rotatable at a rear position of the front support member for allowing tilt adjustment; and
an operation mechanism including a fixed gear secured to the front support member and a movable gear supported to be rotatable by the rear support member to be meshed with the fixed gear, the operation mechanism causing the movable gear to be meshed with the fixed gear to secure the rear support member at a tilt adjusted position with respect to the front support member and releasing the movable gear from the fixed gear at the time of tilt adjusting, wherein:
said fixed gear is integrally formed with a convex part which has a substantially same cross-sectional form in the width direction of the vehicle to face the front support member; and
said front support member is formed with a concave part to be corresponding to the convex part and these convex and concave parts are fitted to each other to secure said fixed gear to the front support member.

2. A tilt-type steering apparatus in which a rear steering column is rockably connected to a rear portion of a front steering column through a support bracket secured to a body of a vehicle, a tilt adjusting lever is rocked to rock, with respect to a fixed gear disposed on one of the support bracket and the rear steering column, a movable gear disposed on the other of the support bracket and the rear steering column, and the teeth of the movable gear are releasably engaged with the teeth of the fixed gear, wherein:
said fixed gear is formed with a convex part while one of said support bracket and said rear steering column is formed with a concave part so that said fixed gear is brought into fitting with said one of said support bracket and said rear steering column; and
the convex part of said fixed gear has a substantially identical cross-sectional form in the width direction of the vehicle.

3. A tilt-type steering apparatus according to claim 2, wherein said fixed gear is formed by sintering or drawing.

4. A tilt-type steering apparatus according to claim 2, wherein the convex part of said fixed gear has an inclined surface in the longitudinal direction of the vehicle.

5. A tilt-type steering apparatus according to claim 2, wherein the convex part of said fixed gear is extended from one side end of said fixed gear in said width direction.

6. A tilt-type steering apparatus according to claim 3, wherein the convex part of said fixed gear has an inclined surface in the longitudinal direction of the vehicle.

7. A tilt-type steering apparatus according to claim 3, wherein the convex part of said fixed gear is extended from one side end of said fixed gear in said width direction.
